(19) United States
(12) Patent Application Publication
(10) Pub. No.: US 2026/0220930 A1
(43) Pub. Date: Jul. 30, 2026

(54) IMAGE PROCESSING DEVICE, IMAGE PROCESSING METHOD, AND PROGRAM

(71) Applicant: Renesas Electronics Corporation, Tokyo (JP)

(72) Inventors: Motoki KIMURA, Tokyo (JP); Hirofumi OHTA, Tokyo (JP)

(21) Appl. No.: 19/404,794

(22) Filed: Dec. 1, 2025

(30) Foreign Application Priority Data
Jan. 29, 2025 (JP) 2025-013383

(51) Int. Cl. G06V 10/82; G06V 10/40; G06V 10/764; G06V 10/776

(52) U.S. Cl. CPC G06V 10/82; G06V 10/40; G06V 10/764; G06V 10/776

(57) ABSTRACT

An image processing device according to the present disclosure generates a feature map based on an image, determines whether a value of each cell of the feature map is equal to or larger than a lower limit threshold value, calculates an activation value by inputting the value of each cell of the feature map equal to or larger than the lower limit threshold value to an activation function, and generates an existence probability map indicating distribution of existence probability of an object in the image by using the activation value.

### CROSS-REFERENCE TO RELATED APPLICATIONS

The disclosure of Japanese Patent Application No. 2025-013383 filed on Jan. 29, 2025 including the specification, drawings and abstract is incorporated herein by reference in its entirety.

### BACKGROUND

The present disclosure relates to an image processing device, an image processing method, and a program.

There is disclosed a technique listed below.
[Patent Document 1] Japanese Unexamined Patent Application Publication No. 2024-023030

A technique for obtaining information from an image by using a neural network has been developed. For example, Patent Document 1 discloses a semiconductor device capable of reducing the time required for image processing by a neural network. The semiconductor device of Patent Document 1 includes a memory for weight parameters in order to prevent transfer of the weight parameters from being a bottleneck in a neural network that processes an image.

### SUMMARY

In Patent Document 1, it is assumed that a memory for weight parameters can be provided. Embodiments to be described later have been made in view of such circumstances, and other problems and novel features will be apparent from the description of the present specification and the accompanying drawings.

When calculating an activation value for a feature map obtained from an image, an image processing device according to an embodiment calculates an activation value for a cell having a value equal to or larger than a lower limit threshold value. Then, the image processing device generates an existence probability map indicating distribution of existence probability of an object in the image by using the calculated activation value.

According to the embodiment, a new technique for processing an image by using a neural network is provided.

### BRIEF DESCRIPTION OF THE DRAWINGS

FIG. 1 is a diagram illustrating an overview of an operation of an image processing device.

FIG. 2 is a block diagram illustrating a functional configuration of the image processing device.

FIG. 3 is a block diagram illustrating a hardware configuration of a computer that implements the image processing device.

FIG. 4 is a first diagram illustrating a configuration of a neural network.

FIG. 5 is a second diagram illustrating a configuration of a neural network.

FIG. 6 is a flowchart illustrating a procedure of processing executed by the image processing device.

FIG. 7 is a diagram illustrating a configuration of the image processing device having an output unit.

### DETAILED DESCRIPTION

Hereinafter, embodiments of the present disclosure will be described in detail with reference to the drawings. In the drawings, the same or corresponding elements are denoted by the same reference numerals, and redundant description is omitted as necessary for clarity of description. In addition, unless otherwise described, values determined in advance such as predetermined values and threshold values are stored in advance in a storage device or the like accessible from a device using the values. Furthermore, unless otherwise described, the storage unit includes any number of one or more storage devices.

### Overview

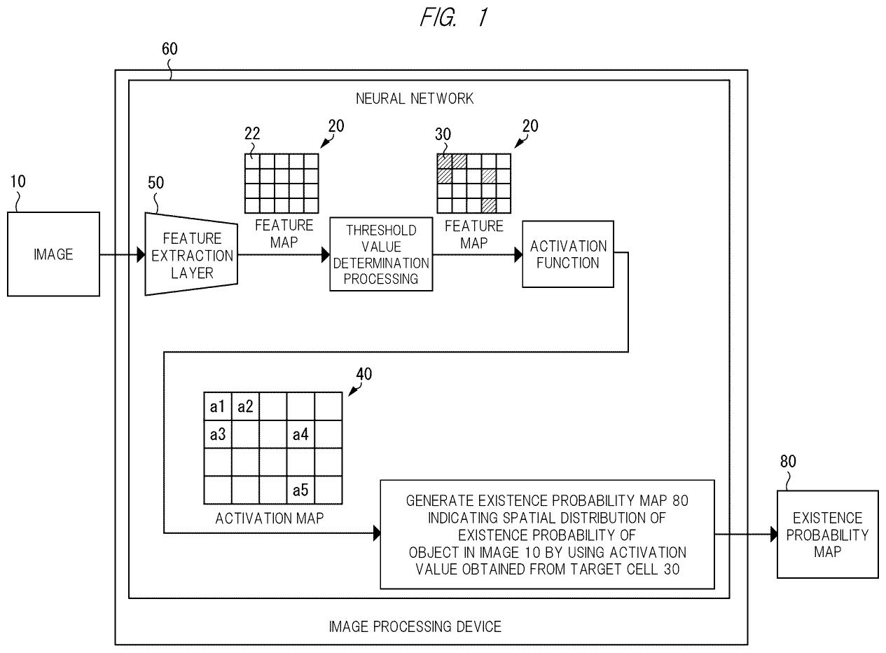

FIG. 1 is a diagram illustrating an overview of an operation of an image processing device 2000. Here, FIG. 1 is a diagram for facilitating understanding of the overview of the image processing device 2000, and the operation of the image processing device 2000 is not limited to that illustrated in FIG. 1.

The image processing device 2000 generates an existence probability map 80 from an image 10 by using a neural network 60. The neural network 60 is configured to output the existence probability map 80 in response to an input of the image 10. The existence probability map 80 indicates the existence probability of the object in each of the plurality of partial regions in the image 10. Here, the existence probability only needs to be a value indicating the degree of likelihood of existence, and does not need to be a value indicating probability. Therefore, the existence probability can take a value larger than 1.

The neural network 60 includes at least a feature extraction layer 50 and an activation function 70. The image 10 or a feature map generated from the image 10 is input to the feature extraction layer 50. The feature map is a tensor indicating a feature amount in each cell. The feature extraction layer 50 generates a feature map 20 from the input image or feature map. The feature extraction layer 50 includes, for example, a convolutional layer, a pooling layer, and the like.

The activation function 70 is an activation function applied to a cell 22 constituting the feature map 20. The activation function may be of any type. The image processing device 2000 generates an activation map 40 from the feature map 20 by using the activation function 70.

Here, the image processing device 2000 applies the activation function 70 only to the cell 22 satisfying a specific condition. Specifically, the image processing device 2000 performs processing of determining whether a value of each cell of the feature map 20 is equal to or larger than a lower limit threshold value (hereinafter, threshold value determination processing). By the threshold value determination processing, the cell having the value equal to or larger than the lower limit threshold value is specified in the feature map 20. Hereinafter, the cell of the feature map 20 having the value equal to or larger than the lower limit threshold value is referred to also as a target cell 30.

The image processing device 2000 inputs the value of each target cell 30 to the activation function 70 to obtain an activation value of each target cell 30, thereby generating the activation map 40. In the activation map 40, the cell at a position (i, j) of the activation map 40 indicates the activation value calculated for the target cell 30 when the cell 22 at a position (i, j) of the feature map 20 is the target cell 30. Also, the cell at the position (i, j) in the activation map 40 indicates a predetermined value such as 0 when the cell 22 at the position (i, j) of the feature map 20 is not the target cell 30.

For example, in the example in FIG. 1, five target cells 30 are specified from the feature map 20. As a result, activation values a1 to a5 are obtained from these five target cells 30. Therefore, the activation map 40 indicates the activation values a1 to a5 for the five cells corresponding to the five target cells 30. Note that, in the activation map 40 in FIG. 1, the values of the cells other than those corresponding to the target cells 30 are omitted.

The image processing device 2000 generates the existence probability map 80 by using the activation value calculated for each target cell 30. For example, the image processing device 2000 uses the activation map 40 directly as the existence probability map 80. In addition, for example, the image processing device 2000 generates the existence probability map 80 by further processing the activation map 40.

### <Example of Operational Effect>

According to the image processing device 2000, the activation values are calculated for the target cells 30, which are the cells 22 having the value equal to or larger than the lower limit threshold value among the cells 22 constituting the feature map 20 obtained from the image 10. Then, the existence probability map 80 is generated using the calculated activation values. As described above, according to the image processing device 2000, a new technique for processing an image using a neural network is provided.

Here, “calculating the activation value only for the cells 22 having the value equal to or larger than the lower limit threshold value rather than calculating the activation value for all the cells 22” has an advantage that it is possible to reduce the number of calculations of the activation value. Then, the reduction in the number of calculations of the activation value leads to the reduction in the time and computer resources required for calculating the activation value. As a result, according to the image processing device 2000, it is possible to reduce the time and computer resources required for calculating the spatial distribution of the existence probability of an object.

Further, the reduction in the accuracy of the object detection can also be prevented by setting the lower limit threshold value appropriately. Therefore, according to the image processing device 2000, the spatial distribution of the existence probability of an object can be accurately calculated while reducing the time and computer resources required for calculating the distribution. Note that a specific method of setting the lower limit threshold value will be described later.

Hereinafter, the image processing device 2000 of the present embodiment will be described in more detail.

### <Example of Functional Configuration>

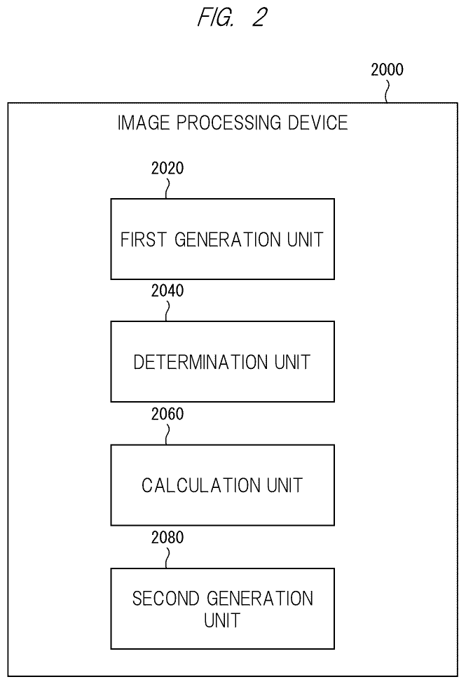

FIG. 2 is a block diagram illustrating a functional configuration of the image processing device 2000. The image processing device 2000 includes a first generation unit 2020, a determination unit 2040, a calculation unit 2060, and a second generation unit 2080. The first generation unit 2020 acquires the image 10 and generates the feature map 20 based on the image 10. The first generation unit 2020 is implemented using the feature extraction layer 50. The determination unit 2040 determines whether the value of each cell 22 of the feature map 20 is equal to or larger than the lower limit threshold value. The calculation unit 2060 applies the value of the target call 30 (cell 22 having the value equal to or larger than the lower limit threshold value) to the activation function 70 to calculate the activation value for each target cell 30. The second generation unit 2080 generates the existence probability map 80 by using the activation value calculated for each target cell 30.

### <Example of Hardware Configuration>

For example, each functional configuration unit of the image processing device 2000 is implemented by hardware (for example, hardwired electronic circuits or the like) that implements each functional configuration unit. In addition, for example, each functional configuration unit of the image processing device 2000 is implemented by a combination of hardware and software (for example, a combination of electronic circuits and a program for controlling the electronic circuits).

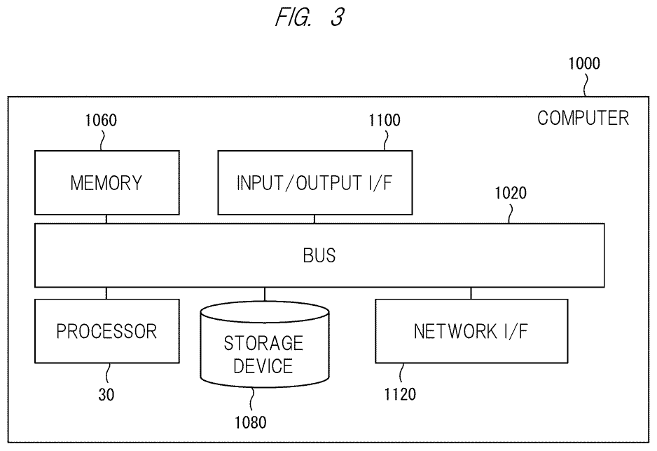

FIG. 3 is a block diagram illustrating a hardware configuration of a computer 1000 that implements the image processing device 2000. The computer 1000 may be any computer. For example, the computer 1000 is a stationary computer such as a personal computer (PC) or a server machine. In addition, for example, the computer 1000 is a portable computer such as a smartphone or a tablet terminal. Further, for example, the computer 1000 is an integrated circuit such as a system on chip (SoC). The computer 1000 may be a dedicated computer designed to implement the image processing device 2000, or may be a general-purpose computer.

For example, by installing a predetermined application in the computer 1000, each function of the image processing device 2000 is implemented in the computer 1000. The above application is configured by a program for implementing each functional configuration unit of the image processing device 2000. Note that any method can be used to acquire the program. For example, the program can be acquired from a storage medium (a digital versatile disc (DVD), a universal serial bus (USB) memory, and the like) in which the program is stored. In addition, for example, the program can be acquired by downloading the program from a server device that manages the storage device in which the program is stored.

The computer 1000 includes a processor 1040, a bus 1020, a memory 1060, a storage device 1080, an input/output interface (I/F) 1100, and a network interface 1120. The bus 1020 is a data transmission path through which the processor 1040, the memory 1060, the storage device 1080, the input/output interface 1100, and the network interface 1120 transmit and receive data to and from each other. However, the method of connecting the processor 1040 and the like to each other is not limited to the bus connection.

The processor 1040 may be any of various processors such as a micro processing unit (MPU), a central processing unit (CPU), a graphics processing unit (GPU), a digital signal processor (DSP), and a field-programmable gate array (FPGA). The memory 1060 is a main storage device implemented using a random access memory (RAM) or the like. The storage device 1080 is an auxiliary storage device implemented using a read only memory (ROM), a flash memory, a memory card, or the like. The input/output interface 1100 is an interface for connecting the computer 1000 and an input/output device. The network interface 1120 is an interface for connecting the computer 1000 to the network.

The storage device 1080 stores a program for implementing each functional configuration unit of the image processing device 2000 (a program for implementing the above-described application). The processor 1040 loads the program into the memory 1060 and executes the program to implement each functional configuration unit of the image processing device 2000.

The image processing device 2000 may be implemented by one computer 1000 or may be implemented by a plurality of computers 1000. In the latter case, the configurations of the computers 1000 do not need to be the same, and can be different from each other.

### <Configuration of Neural Network 60>

As described above, the neural network 60 includes at least the feature extraction layer 50 and the activation function 70. Any configuration may be applied as a specific configuration of the neural network 60 described above. Here, some specific configurations of the neural network 60 will be exemplified.

### Example 1

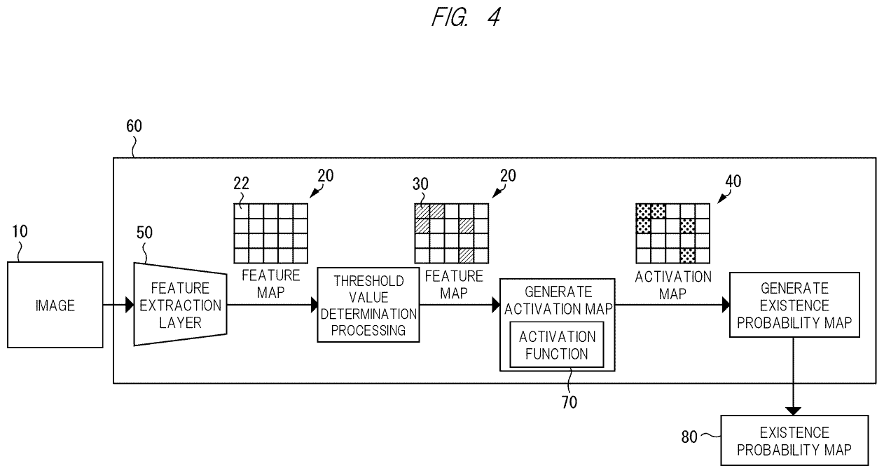

FIG. 4 is a first diagram illustrating a configuration of the neural network 60. In FIG. 4, the neural network 60 includes the feature extraction layer 50 and the activation function 70. The first generation unit 2020 inputs the image 10 to the feature extraction layer 50. The feature extraction layer 50 outputs the feature map 20 in response to the input of the image 10.

The determination unit 2040 determine whether the value of each cell 22 of the feature map 20 output from the feature extraction layer 50 is equal to or larger than the lower limit threshold value. The calculation unit 2060 calculates the activation value for each target cell 30 by inputting each target cell 30 which is the cell having the value equal to or larger than the lower limit threshold value to the activation function 70.

The calculation unit 2060 generates the activation map 40 by using the calculated activation value. The activation map 40 indicates at least the activation value obtained from the target cell 30. In FIG. 4, the cell with a dotted pattern in the activation map 40 is the cell in which the activation value obtained from the corresponding target cell 30 is indicated.

For example, in the feature map 20, it is assumed that the cell 22 at the position (i, j) is the target cell 30. In this case, the cell at the position (i, j) in the activation map 40 indicates the activation value calculated from the target cell 30 at the position (i, j). On the other hand, in the feature map 20, it is assumed that the cell 22 at the position (i, j) is not the target cell 30. In this case, the cell at the position (i, j) in the activation map 40 indicates a predetermined value (for example, 0).

The activation map 40 is input to the second generation unit 2080. The second generation unit 2080 generates the existence probability map 80 by using the input activation value. For example, the second generation unit 2080 uses the activation map 40 directly as the existence probability map 80.

Here, the image processing device 2000 may generate the existence probability map 80 for each of multiple types (hereinafter, referred to also as class) of objects. For example, it is assumed that the image 10 is an image obtained from a camera mounted on a vehicle. In this case, the image processing device 2000 can be used to detect various classes of objects such as a person, a vehicle, a building, and a guardrail.

As described above, in a case where the existence probability map 80 is generated for each of the multiple types of objects, for example, the neural network 60 includes the feature extraction layer 50 for each type of object. Specifically, the neural network 60 includes the feature extraction layer 50 used to generate the existence probability map 80 indicating the existence probability of a person, the feature extraction layer 50 used to generate the existence probability map 80 indicating the existence probability of a vehicle, and the like.

### Example 2

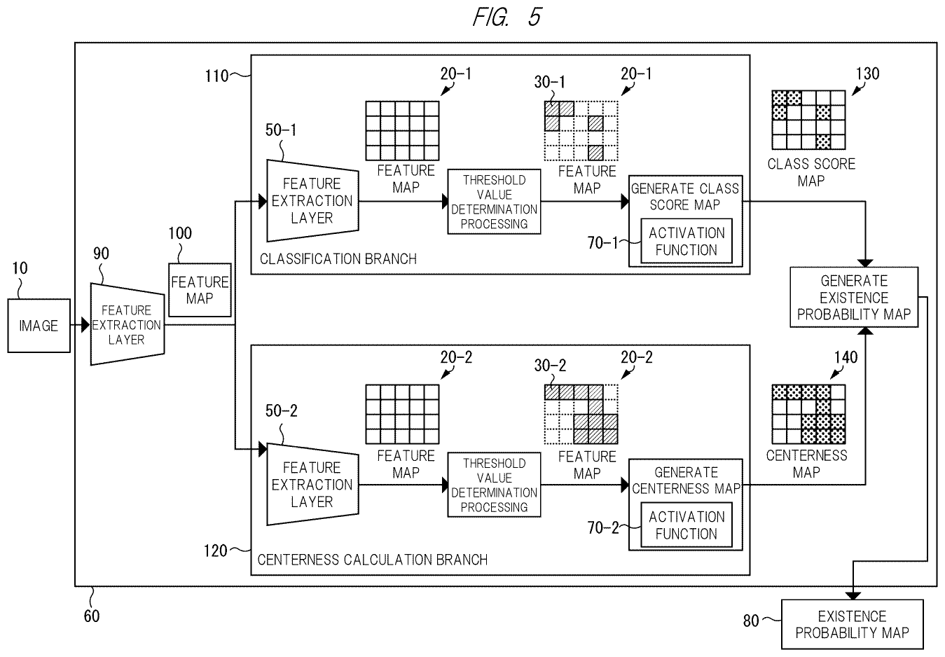

FIG. 5 is a second diagram illustrating a configuration of the neural network 60. In the example of FIG. 5, the neural network 60 is a fully convolutional one-stage object detection (FCOS)-based neural network.

The neural network 60 of FIG. 5 includes a feature extraction layer 90, a classification branch 110, and a centerness calculation branch 120.

The image processing device 2000 inputs the image 10 to the feature extraction layer 90. The feature extraction layer 90 outputs a feature map 100 in response to the input of the image 10. The feature map 100 is input to both the classification branch 110 and the centerness calculation branch 120. Therefore, it can be said that the feature map 100 represents distribution of the feature amounts obtained from the image 10 useful for both the task realized by the classification branch 110 and the task realized by the centerness calculation branch 120.

In the classification branch 110, a class score map 130 is generated from the feature map 100. The class score map 130 indicates spatial distribution of class scores. The class score represents the probability that an object of a particular class exists in an image region of the image 10 corresponding to each cell of the feature map 100.

More specifically, in the classification branch 110, when the first generation unit 2020 inputs the feature map 100 to a feature extraction layer 50-1, a feature map 20-1 is output from the feature extraction layer 50-1. The feature extraction layer 50-1 is one of the plurality of feature extraction layers 50 included in the neural network 60. The feature map 20-1 is one of the plurality of feature maps 20 generated by the neural network 60.

The determination unit 2040 specifies a target cell 30-1 from the feature map 20-1 by performing the threshold value determination processing on the feature map 20-1. The target cell 30-1 is the target cell 30 specified in the feature map 20-1. More specifically, the determination unit 2040 determines whether the value of each cell of the feature map 20-1 is equal to or larger than the lower limit threshold value. The determination unit 2040 specifies the cell of the feature map 20-1 having the value equal to or larger than the lower limit threshold value as the target cell 30-1.

The calculation unit 2060 inputs each target cell 30-1 to an activation function 70-1 to calculate the activation value for each target cell 30-1. The activation function 70-1 is one of the plurality of activation functions 70 included in the neural network 60.

The calculation unit 2060 generates the class score map 130 by using the activation value obtained from each target cell 30-1. The class score map 130 is the activation map generated using the activation value obtained from each target cell 30-1. As in the activation map 40, when the cell at the position (i, j) in the feature map 20-1 is not the target cell 30-1, the cell at the position (i, j) in the class score map 130 indicates a predetermined value (for example, 0).

In the centerness calculation branch 120, a centerness map 140 is generated from the feature map 100. The centerness map 140 indicates a centerness value for each cell. The centerness map 140 indicates how close the image region of the image 10 corresponding to each cell of the feature map 100 is to the center of the object.

More specifically, in the centerness calculation branch 120, when the first generation unit 2020 inputs the feature map 100 to a feature extraction layer 50-2, a feature map 20-2 is output from the feature extraction layer 50-2. The feature extraction layer 50-2 is one of the plurality of feature extraction layers 50 included in the neural network 60. The feature map 20-2 is one of the plurality of feature maps 20 generated by the neural network 60.

The determination unit 2040 specifies a target cell 30-2 from the feature map 20-2 by performing the threshold value determination processing on the feature map 20-2. The target cell 30-2 is the target cell 30 specified in the feature map 20-2. More specifically, the determination unit 2040 determines whether the value of each cell of the feature map 20-2 is equal to or larger than the lower limit threshold value. The determination unit 2040 specifies the cell of the feature map 20-2 having the value equal to or larger than the lower limit threshold value as the target cell 30-2.

The calculation unit 2060 inputs each target cell 30-2 to an activation function 70-2 to calculate the activation value for each target cell 30-2. The activation function 70-2 is one of the plurality of activation functions 70 included in the neural network 60.

The calculation unit 2060 generates the centerness map 140 by using the activation value obtained from each target cell 30-2. The centerness map 140 is the activation map generated using the activation value obtained from each target cell 30-2. As in the activation map 40, when the cell at the position (i, j) in the feature map 20-2 is not the target cell 30-2, the cell at the position (i, j) in the centerness map 140 indicates a predetermined value (for example, 0).

The second generation unit 2080 generates the existence probability map 80 by using the class score map 130 and the centerness map 140. For example, the second generation unit 2080 generates the existence probability map 80 by calculating a cell-wise product between the class score map 130 and the centerness map 140.

The operation of calculating the cell-wise product between the two maps means an operation of calculating the product between cells at the same positions. For example, in the existence probability map 80, the value of the cell at the position (i, j) indicates the product of the value of the cell at the position (i, j) in the class score map 130 and the value of the cell at the position (i, j) in the centerness map 140. As described above, the image processing device 2000 may generate the existence probability map 80 for each of the plurality of classes. In a case where the existence probability map 80 is generated for each of the plurality of classes, the neural network 60 generates the class score map 130 for each class. For this purpose, the feature extraction layer 50-1 is prepared for each class. For each class, the second generation unit 2080 calculates the cell-wise product between the class score map 130 generated for the class and the centerness map 140 to generate the existence probability map 80 for the class.

### <Procedure of Processing>

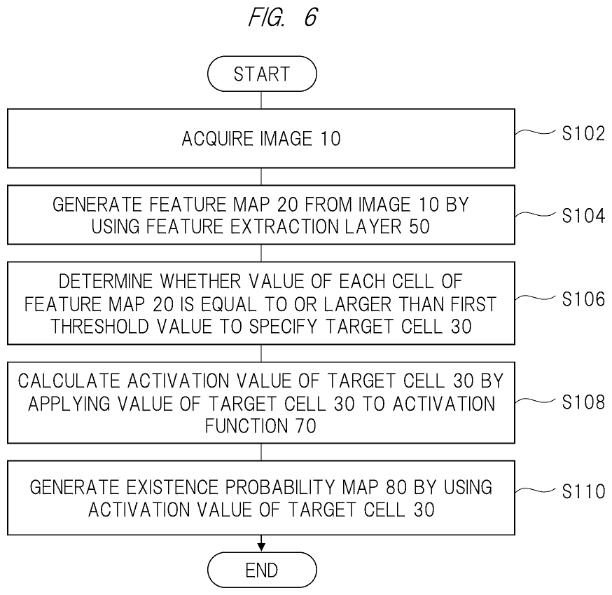

FIG. 6 is a flowchart illustrating a procedure of processing executed by the image processing device 2000. The first generation unit 2020 acquires the image 10 (S102). The first generation unit 2020 generates the feature map 20 based on the image 10 (S104). The determination unit 2040 determines whether the value of each cell of the feature map 20 is equal to or larger than the lower limit threshold value to specify the target cell 30 (each cell 22 having the value equal to or larger than the lower limit threshold value) (S106). The calculation unit 2060 calculates the activation value for the target cell 30 (S108). The second generation unit 2080 generates the existence probability map 80 based on the activation value calculated for each target cell 30 (S110).

### <Acquisition of Image 10: S102>

The first generation unit 2020 acquires the image 10 (S102). Various methods can be adopted as a method of acquiring an image to be processed. For example, the image 10 is stored in a storage unit accessible from the image processing device 2000. The first generation unit 2020 acquires the image 10 stored in the storage unit.

For example, a user of the image processing device 2000 designates an image to be treated as the image 10 by designating a file name or the like. The first generation unit 2020 acquires the image designated by the user from the storage unit as the image 10.

In addition, for example, the image 10 is transmitted from a device other than the image processing device 2000 to the image processing device 2000. In this case, the first generation unit 2020 receives an image transmitted from another device and handles the image as the image 10.

Any device can transmit the image 10 to the image processing device 2000. For example, the device is a camera that has generated the image 10. In this case, for example, the image processing device 2000 detects an object from the image 10 generated by the camera. For example, in a case where a camera is provided in a vehicle, a situation around the vehicle is captured in the image 10. Therefore, by generating the existence probability map 80 from the image 10 by using the image processing device 2000, it is possible to grasp the distribution of the existence probability of the object around the vehicle.

### <Generation of Feature Map 20: S104>

The first generation unit 2020 generates the feature map 20 based on the image 10 by using the feature extraction layer 50 (S104). As described above, for example, the feature extraction layer 50 is configured to generate the feature map 20 in response to an input of an image (see FIG. 4). In this case, the first generation unit 2020 obtains the feature map 20 from the feature extraction layer 50 by inputting the image 10 to the feature extraction layer 50.

In addition, for example, the feature extraction layer 50 is configured to generate the feature map 20 in response to an input of a feature map (see FIG. 5). In this case, the first generation unit 2020 obtains the feature map 20 by inputting a feature map generated from the image 10 to the feature extraction layer 50.

### <Threshold Value Determination Processing: S106>

The determination unit 2040 determines whether the value of each cell 22 of the feature map 20 is equal to or larger than the lower limit threshold value to specify the target cell 30 (S106). When the value of the cell 22 is equal to or larger than the lower limit threshold value, the determination unit 2040 specifies the cell 22 as the target cell 30. On the other hand, when the value of the cell 22 is not equal to or larger than the lower limit threshold value, the determination unit 2040 does not specify the cell 22 as the target cell 30.

### <<Determination Method of Lower Limit Threshold Value>>

The lower limit threshold value can be determined in various ways. For example, the lower limit threshold value is manually determined by an administrator or a user of the image processing device 2000.

In addition, for example, the lower limit threshold value may be determined as follows based on the relationship with the activation value. Here, the lower limit threshold value is preferably determined such that the activation value obtained from the target cell 30 becomes relatively large to some extent. That is, it is preferable that the lower limit threshold value is determined such that the cell 22 in which the activation value becomes relatively large is specified as the target cell 30 and the cell 22 in which the activation value becomes relatively small is not specified as the target cell 30.

Therefore, first, a threshold value (hereinafter, second threshold value) is determined for the activation value obtained using the activation function 70, for example. The second threshold value is, for example, a threshold value used to determine whether an object exists (hereinafter, probability threshold value). The lower limit threshold value is calculated by inputting the second threshold value to an inverse function of the activation function 70. For example, in a case where the activation function 70 is a sigmoid function, the inverse function is a logit function.

Specifically, the lower limit threshold value Th is calculated as follows using the second threshold value T2.

$$\begin{matrix}[ Math . 1 ] & \\ Th = {f}^{- 1} ( T 2 ) & ( 1 )\end{matrix}$$

Here, f\hat{ }−1( ) represents an inverse function of the activation function 70. Therefore, f( ) represents the activation function 70.

For example, as illustrated in FIG. 4, it is assumed that the activation map 40 is directly used as the existence probability map 80. In this case, the above-described probability threshold value can be used as the second threshold value T2. For example, in the existence probability map 80, it is assumed that an image region of the image 10 corresponding to the cell having the value of 0.8 or more is treated as the image region in which an object exists. In this case, the probability threshold value is 0.8. Therefore, 0.8 is used as T2.

Here, a function having no inverse function over its entire domain region may also be used as the activation function 70. In this case, the inverse function f−1( ) is defined by extracting, from the activation function 70, a range in which the inverse function can be defined and the second threshold value is included in the value range. Then, the lower limit threshold value is calculated from the second threshold value by using the inverse function f−1( ).

### <Generation of Existence Probability Map 80: S110>

The second generation unit 2080 generates the existence probability map 80 by using the activation value calculated for each target cell 30 (S108). For example, as in the example described with reference to FIG. 4, the second generation unit 2080 can use the activation map 40 directly as the existence probability map 80. In addition, for example, as in the example described with reference to FIG. 5, the second generation unit 2080 generates the existence probability map 80 from the two activation maps (the class score map 140 and the centerness map 140).

### <Output of Result>

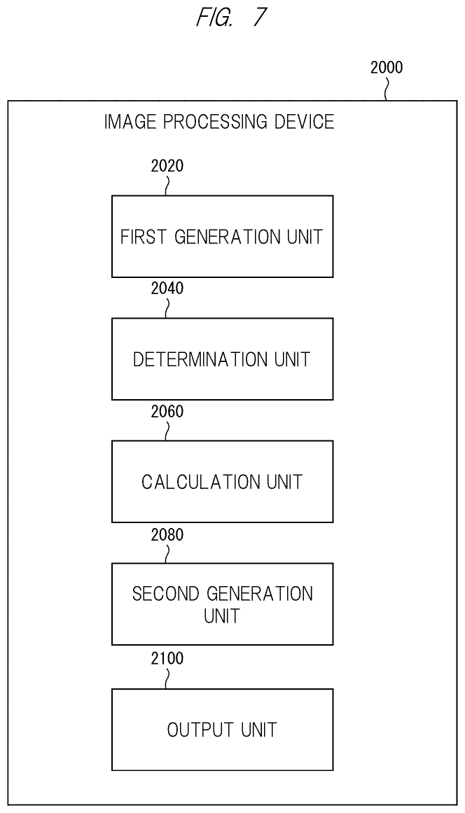

The image processing device 2000 outputs information indicating the processing result (hereinafter, output information). The functional configuration unit that outputs the output information is referred to as an output unit. FIG. 7 is a diagram illustrating a configuration of the image processing device 2000 having the output unit.

Any kind of information may be included in the output information. For example, an output unit 2100 generates output information including the existence probability map 80. Here, when the existence probability map 80 is generated for each of the plurality of classes, the output information may include the existence probability map 80 for each class.

Note that, by using the existence probability map 80 obtained for each class, data (for example, a vector) indicating the existence probability of the object of each class is obtained for each region of the image 10 corresponding to each cell of the existence probability map 80. For example, it is assumed that the existence probability map 80 is generated for each of the three types of classes C1, C2, and C3. In this case, the image processing device 2000 can obtain a vector (L1[i, j], L2[i, j], L3[i, j]) in which the existence probability L1[i, j] of the object of the class C1, the existence probability L2[i, j] of the object of the class C2, and the existence probability L3[i, j] of the object of the class C3 are listed for each position (i, j).

Any mode may be applied to the output mode of the output information. For example, the output unit 2100 stores the output information in any storage unit. In addition, for example, the output unit 2100 outputs the output information to any display device to cause the display device to display the output information. In addition, for example, the output unit 2100 transmits the output information to another device.

### <Training of Neural Network 60>

The neural network 60 is trained in advance. The training of the neural network 60 is performed using a plurality of training samples. The training sample is, for example, a pair of a training image and a ground-truth map indicating spatial distribution of existence probability of an object in the training image. The ground-truth map indicates the ideal existence probability map 80 to be output from the neural network 60 in response to the input of the training image.

A device that performs the training of the neural network 60 (hereinafter, the training device) calculates a loss by using the existence probability map 80 obtained by inputting the training image to the neural network 60 and the ground-truth map. Further, the training device updates the trainable parameters (weight, bias, and the like) included in the neural network 60 by using the calculated loss. The training device trains the neural network 60 by repeating parameter update by using a plurality of training samples.

In the foregoing, the present disclosure has been described with reference to the embodiments, but the present disclosure is not limited to the embodiments described above. Various modifications that can be understood by those skilled in the art can be made to the configuration and details of the present disclosure within the scope of the present disclosure. In addition, each embodiment can be combined with other embodiments as appropriate.

Each drawing is merely an illustration provided for describing one or more embodiments. Each drawing is not necessarily associated with only one particular embodiment, but may be associated with one or more other embodiments. As will be understood by those skilled in the art, various features or steps described with reference to any one of the drawings may be combined with features or steps illustrated in one or more other drawings, for example, in order to produce embodiments that are not explicitly illustrated or described. All of the features or steps illustrated in any one of the drawings for describing embodiments are not necessarily essential, and some features or steps may be omitted. The order of the steps described in any drawing may be changed as appropriate.

In the present disclosure, a program includes a group of instructions (or software code) for causing a computer to execute one or more functions described in the embodiments when the program is loaded into the computer. The program may be stored in a non-transitory computer-readable medium or a tangible storage medium. By way of example and not limitation, the computer-readable medium or tangible storage medium may include random-access memory (RAM), read-only memory (ROM), flash memory, solid-state drive (SSD) or other memory technologies, CD-ROM, digital versatile disc (DVD), Blu-ray (registered trademark) disc or other optical disk storages, magnetic cassette, magnetic tape, magnetic disk storage, or other magnetic storage devices. The program may be transmitted on a transitory computer-readable medium or a communication medium. By way of example and not limitation, the transitory computer-readable medium or communication medium may include propagated signals in electrical, optical, acoustic, or other forms.

### SUPPLEMENTARY NOTES

### Supplementary Note 1

An image processing device including:
a first generation unit configured to generate a feature map based on an image;
a determination unit configured to determine whether a value of each cell of the feature map is equal to or larger than a lower limit threshold value;
a calculation unit configured to calculate an activation value by inputting the value of the cell equal to or larger than the lower limit threshold value to an activation function; and
a second generation unit configured to generate an existence probability map indicating distribution of existence probability of an object in the image by using the activation value.

### Supplementary Note 2

The image processing device according to supplementary note 1,
wherein the existence probability map indicates:
the activation value for a cell corresponding to the cell of the feature map having the value equal to or larger than the lower limit threshold value; and
a predetermined value for a cell corresponding to the cell of the feature map having the value smaller than the lower limit threshold value.

### Supplementary Note 3

The image processing device according to supplementary note 1,
wherein the first generation unit generates a first of the feature map and a second of the feature map,
wherein the determination unit is configured to:
determine whether a value of each cell of the first of the feature map is equal to or larger than a first of the lower limit threshold value; and
determine whether a value of each cell of the second of the feature map is equal to or larger than a second of the lower limit threshold value, and
wherein the second generation unit is configured to:
generate a class map indicating distribution of existence probability of an object of a particular class by using the activation value calculated for the cell of the first of the feature map having the value equal to or larger than the first of the lower limit threshold value;
generate a centerness map indicating distribution of proximity from a center of an object by using the activation value calculated for the cell of the second of the feature map having the value equal to or larger than the second of the lower limit threshold value; and
generate the existence probability map for the object of the particular class by using the class map and the centerness map.

### Supplementary Note 4

The image processing device according to supplementary note 3,
wherein the class map indicates:
the activation value for a cell corresponding to the cell of the first of the feature map having the value equal to or larger than the first of the lower limit threshold value; and
a first predetermined value for a cell corresponding to the cell of the first of the feature map having the value smaller than the first of the lower limit threshold value, and
wherein the centerness map indicates:
the activation value for a cell corresponding to the cell of the first of the feature map having the value equal to or larger than the second of the lower limit threshold value; and
a second predetermined value for a cell corresponding to the cell of the second of the feature map having the value smaller than the second of the lower limit threshold value.

### Supplementary Note 5

The image processing device according to supplementary note 1,
wherein the lower limit threshold value is obtained by inputting a probability threshold value used to determine whether an object exists to an inverse function of the activation function.

### Supplementary Note 6

An image processing method executed by a computer, the method including:
a first generation step of generating a feature map based on an image;
a determination step of determining whether a value of each cell of the feature map is equal to or larger than a lower limit threshold value;
a calculation step of calculating an activation value by inputting the value of the cell equal to or larger than the lower limit threshold value to an activation function; and
a second generation step of generating an existence probability map indicating distribution of existence probability of an object in the image by using the activation value.

### Supplementary Note 7

A program for causing a computer to execute a process including:
a first generation step of generating a feature map based on an image;
a determination step of determining whether a value of each cell of the feature map is equal to or larger than a lower limit threshold value;
a calculation step of calculating an activation value by inputting the value of the cell equal to or larger than the lower limit threshold value to an activation function; and
a second generation step of generating an existence probability map indicating distribution of existence probability of an object in the image by using the activation value.

### Supplementary Note 8

An image processing device including:
one or more storage elements in which an instruction is stored; and
one or more processors,
wherein the one or more processors execute the instruction to:
generate a feature map based on an image;
determine whether a value of each cell of the feature map is equal to or larger than a lower limit threshold value;
calculate an activation value by inputting the value of the cell equal to or larger than the lower limit threshold value to an activation function; and
generate an existence probability map indicating distribution of existence probability of an object in the image by using the activation value.

### Supplementary Note 9

A non-transitory computer readable storage medium storing a program for causing a computer to execute a process including:
a first generation step of generating a feature map based on an image;
a determination step of determining whether a value of each cell of the feature map is equal to or larger than a lower limit threshold value;
a calculation step of calculating an activation value by inputting the value of the cell equal to or larger than the lower limit threshold value to an activation function; and
a second generation step of generating an existence probability map indicating distribution of existence probability of an object in the image by using the activation value.

Some or all of the elements (for example, configurations and functions) described in supplementary notes 2 to 5 dependent on supplementary note 1 can also be dependent on each of supplementary notes 6 to 9 by the same dependency relationship as that of supplementary notes 2 to 5. Some or all of the elements described in any supplementary note may be applied to various hardware, software, a recording unit for recording software, a system, and a method.

What is claimed is:

1. An image processing device comprising:
a first generation unit configured to generate a feature map based on an image;
a determination unit configured to determine whether a value of each cell of the feature map is equal to or larger than a lower limit threshold value;
a calculation unit configured to calculate an activation value by inputting the value of the cell equal to or larger than the lower limit threshold value to an activation function; and
a second generation unit configured to generate an existence probability map indicating distribution of existence probability of an object in the image by using the activation value.

2. The image processing device according to claim 1,
wherein the existence probability map indicates:
the activation value for a cell corresponding to the cell of the feature map having the value equal to or larger than the lower limit threshold value; and
a predetermined value for a cell corresponding to the cell of the feature map having the value smaller than the lower limit threshold value.

3. The image processing device according to claim 1,
wherein the first generation unit generates a first of the feature map and a second of the feature map,
wherein the determination unit is configured to:
determine whether a value of each cell of the first of the feature map is equal to or larger than a first of the lower limit threshold value; and
determine whether a value of each cell of the second of the feature map is equal to or larger than a second of the lower limit threshold value, and
wherein the second generation unit is configured to:
generate a class map indicating distribution of existence probability of an object of a particular class by using the activation value calculated for the cell of the first of the feature map having the value equal to or larger than the first of the lower limit threshold value;
generate a centerness map indicating distribution of proximity from a center of an object by using the activation value calculated for the cell of the second of the feature map having the value equal to or larger than the second of the lower limit threshold value; and
generate the existence probability map for the object of the particular class by using the class map and the centerness map.

4. The image processing device according to claim 3,
wherein the class map indicates:
the activation value for a cell corresponding to the cell of the first of the feature map having the value equal to or larger than the first of the lower limit threshold value; and
a first predetermined value for a cell corresponding to the cell of the first of the feature map having the value smaller than the first of the lower limit threshold value, and
wherein the centerness map indicates:
the activation value for a cell corresponding to the cell of the first of the feature map having the value equal to or larger than the second of the lower limit threshold value; and
a second predetermined value for a cell corresponding to the cell of the second of the feature map having the value smaller than the second of the lower limit threshold value.

5. The image processing device according to claim 1,
wherein the lower limit threshold value is obtained by inputting a probability threshold value used to determine whether an object exists to an inverse function of the activation function.

6. An image processing method executed by a computer, the method comprising:
a first generation step of generating a feature map based on an image;
a determination step of determining whether a value of each cell of the feature map is equal to or larger than a lower limit threshold value;
a calculation step of calculating an activation value by inputting the value of the cell equal to or larger than the lower limit threshold value to an activation function; and
a second generation step of generating n existence probability map indicating distribution of existence probability of an object in the image by using the activation value.

7. A computer readable storage medium storing a program for causing a computer to execute a process comprising:
a first generation step of generating a feature map based on an image;
a determination step of determining whether a value of each cell of the feature map is equal to or larger than a lower limit threshold value;
a calculation step of calculating an activation value by inputting the value of the cell equal to or larger than the lower limit threshold value to an activation function; and
a second generation step of generating an existence probability map indicating distribution of existence probability of an object in the image by using the activation value.
